(19) United States
(12) Patent Application Publication
(10) Pub. No.: US 2005/0234172 A1
(43) Pub. Date: Oct. 20, 2005

(54) Random copolymer-impact copolymer blend

(75) Inventors: Mike Musgrave, Houston, TX (US); LuAnn Kelly, Friendswood, TX (US); Mark Murphy, Baytown, TX (US); John Ashbaugh, Houston, TX (US)

Correspondence Address: David J. Alexander;Fina Technology, Inc., P.O. Box 674412, Houston, TX, 77267-4412, US

(73) Assignee: FINA Technology, Inc., Houston, TX (US)

(21) Appl. No.: 10/827,185

(22) Filed: Apr. 19, 2004

(51) Int. Cl. C08K 5/05

(52) U.S. Cl. 524/379

(57) ABSTRACT

The present invention provides a blend comprising an impact copolymer, a random copolymer and a clarifying agent. The invention further includes a process for forming a resin comprising the blend and having desirable optical and physical properties, in particular, low temperature impact. The present invention further includes a method of manufacturing articles and articles comprising the blend.

### TECHNICAL FIELD OF THE INVENTION

The present invention is directed, in general, to a resin comprising a blend of clarified ethylene-propylene random copolymer and polypropylene impact copolymer. The resin exhibits sufficient toughness and clarity to allow its use in low temperature rigid packaging applications.

### BACKGROUND OF THE INVENTION

The use of resins, which contain polymerized propylene, for the production of articles used in low temperature packaging applications represents a substantial commercial market. Two desirable properties such resins should have are reasonably good clarity and sufficient toughness to withstand normal handling at refrigerated or freezer temperatures (i.e., less than about 5° C.). Previously proposed such resins, however, have lacked both of these properties.

For example, resins containing polymerized propylene only, defined as homopolymers of polypropylene (PP), while having good clarity, have poor impact resistance at low temperature. It is known that low temperature impact resistance may be improved by dispersing into the crystalline polypropylene phase a rubber phase comprising, for example, ethylene-propylene (EP) copolymers, to produce an impact copolymer (ICP). However, such mixtures inherently exhibit reduced clarity. Procedures proposed to improve clarity include reducing the particle size in the rubber phase, or matching the refractive index of the crystalline and rubber phases, have not been entirely successful. Moreover, certain in situ or physical blends of crystalline or rubber phases may have unacceptable optical or physical properties at low temperatures for certain commercial applications. Alternatively, random copolymers (RCP), comprising a single propylene phase with a comonomer, such as ethylene, incorporated therein may have good clarity, but deficit low temperature impact resistance.

Consider, for instance, the glass transition temperature. Tg, the temperature at which the polymer chains in the amorphous regions of the polymer lose their mobility. Adding a comonomer like ethylene (C2) at between 1-4% by weight will increase the amorphous regions (as exhibited by higher xylene extractables), but will not increase the mobility of the amorphous polymer chains appreciably. At best, the Tg of a medium ethylene (2-4% by weight) random copolymer might drop a few degrees. Several problems associated with adding a comonomer relate to the subsequent drop in polymer crystallinity, including: lower flexural modulus; lower melting point and maximum service or use temperature; lower surface hardness; and lower recrystallization temperatures which, in turn, affects process speeds.

Accordingly, what is needed is a propylene containing resin having acceptable clarity and low temperature impact resistance, while not experiencing the above-mentioned problems.

### SUMMARY OF THE INVENTION

To address the above-discussed deficiencies, the present invention provides, a blend comprising about 20 wt % to about 60 wt % of an impact copolymer, about 300 to about 4000 ppm by weight of a clarifying agent and a random copolymer comprising a balance of the blend. Another embodiment is a process for forming a resin comprising the blend. Yet another embodiment is a method of manufacturing articles comprising the above-described blend. Still another embodiment is an article manufactured from a resin comprising the blend.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the scope of the invention.

### DETAILED DESCRIPTION

The present invention discloses the hitherto unrecognized ability of a blend, comprising an ICP, a RCP and a clarifying agent (CA) having acceptable haze and impact resistance for low temperature packaging applications, involving refrigerated and freezer temperatures. In certain advantageous embodiments, the blend comprises from about 20 wt % to about 60 wt %, and more preferably about 30 wt % to about 50 wt %, and even more preferably about 30 wt %, of the Impact Copolymer (ICP). The blend also comprises about 300 to about 4000 ppm of the CA. The balance of the blend is comprised of the RCP.

Both the ICP and RCP may be prepared using conventional catalysts, well-known to those of ordinary skill in the art. Non-limiting examples of such catalysts include Zigler-Natta or metallocene catalysts. In an advantageous embodiment, however, metallocene catalysts are preferred because the metallocene-based polypropylene produced therefrom exhibits higher clarity, due to smaller and more uniform crystal sizes, a smoother/higher gloss surface, and greater tensile strength. In addition, RCPs made with a metallocene catalyst are clearer than typical Zigler-Natta-based random copolymers, due to more random incorporation of the comonomer (e.g., ethylene). Examples of such metallocene catalysts that can be used are disclosed in U.S. Patent Application Publication No. 2002/0137623, Ser. No. 09/782,753, filed on Feb. 13, 2001, which is incorporated herein in its entirety by reference.

The ICP comprises a crystalline composition and a rubber-like, or amorphous rubber, composition. The amorphous rubber composition preferably comprises about 7 to about 22 wt % of the ICP, and more preferably about 10 to about 18 wt %, with the balance comprising the crystalline composition. In certain preferred embodiments, the ICP has a melt flow (MF) that may be adjusted depending on the desired end use, but is typically in the range of about 0.1 dg/min to about 5 dg/min, and more preferably about 0.75 to about 3.5 dg/min.

In other advantageous embodiments, the ICP preferably has a melting temperature (Tm), as determined by differential scanning calorimetry, of about 148 to about 167° C., more preferably about 159 to about 165° C., and even more preferably about 159 to about 163° C. In some embodiments, a Tm of about 159° C. is obtained by incorporating about 0.6% ethylene into the continuous homopolymer crystalline phase. In certain embodiments in which a metallocene is used to make the ICP, the resulting ICP has a Tm of about 148 to about 152° C.

Some embodiments of the crystalline composition of the ICP are a homopolymer, such as isotactic polypropylene (iPP). In other embodiments, crystalline composition includes a small amount of a second crystalline composition comonomer. For example, less than about 5 wt %, and more preferably less than about 3.5 wt %, of the second crystalline composition comonomer may be incorporated to obtain particular properties. The comonomer may comprise any alpha olefin having 2-10 carbon atoms. Two common examples are ethylene or 1-butene. In some preferred embodiments, such as metallocene-based ICPs, the comonomers are incorporated with the propylene in a controlled fashion allowing for a more random distribution throughout the chains. Such metallocene-based ICPs advantageously have lower stiffness and improved low temperature impact strength compared to a polypropylene homopolymer. One of ordinary skill in the art would understand, however, that the amount and type of comonomer incorporated into the homopolymer may be adjusted to provide the specific properties of the ICP that are desired.

Some embodiments of the ICP contain a nucleator. As well understood by those skilled in the art nucleators, such as talc and sodium benzoate, are included to promote crystallization of the ICP. In certain preferred embodiments it is advantageous to use a non-nucleated ICP where the nucleator and clarifying agent may interact to result in an ICP having reduced clarity. For example, an ICP having sodium benzoate nucleator and sorbitol-based clarifying agent may result in a blend with undesirably high haze.

Preferred embodiments of the amorphous rubber composition are ethylene-propylene block copolymers having a lower molecular weight (MW) olefin component of ethylene, and a higher molecular weight component of propylene. In certain aspects, either the low or high MW olefin components of the rubber may comprise an alpha olefin having between 2-10 carbon atoms. Of course, combinations of other lower and higher MW olefin components comprising the copolymer may be used depending on the particular product properties desired. Examples include propylene/butene, hexene or octene copolymers, and ethylene/butene, hexene or octene copolymers, and propylene/ethylene/hexene-1 terpolymers. Ethylene-propylene diene terpolymers and related elastomeric ethylene propylene copolymers may also be used.

In yet other advantageous embodiments, the amorphous rubber composition in the ICP includes sufficient amount of a lower MW olefin such that the comonomer ratio of ethylene to propylene (i.e., low MW component:high MW component) is between about 30:70 to about 50:50, by weight, and more preferably between about 35:65 to about 45:55, and even more preferably between about 39:61 to about 41:59. One of ordinary skill in the art would understand, however, that the ratio of comonomers in the amorphous rubber composition may be adjusted to provide the specific balance of mechanical, impact and optical properties of the ICP that are desired.

The RCP comprises the incorporation of propylene with an alpha olefin, having between 2-10 carbon atoms, randomly inserted between the propylene groups. Preferably, there are no consecutive sequences of such alpha olefin groups. In certain embodiments using a metallocene catalyzed random copolymer (i.e., a RCP made using a metallocene catalyst), the alpha olefin content may range from about 0.15 to about 4 wt %, and more preferably between about 0.6 and 4 wt %. In another embodiment, which also uses a metallocene catalyzed RCP, the alpha olefin content may range from about 0.2 and to about 3 wt %, and more preferably from about 0.2 and to about 2 wt %.

The RCP may have a Tm of less than about 160° C. and more preferably a Tm that ranges from about 140 and to about 150° C. Certain preferred embodiments of the RCP have a melt flow (MF) that may be adjusted depending on the desired end use, but is typically in the range of about 0.1 to about 10 g/10 min, and more preferably about 0.7 to about 4.0 g/10 min.

In some preferred embodiments of the blend include a CA having a substituted dibenylidene sorbitol. Preferred embodiments of the blend having such CAs include between about 1700 to about 4000 ppm of CA by weight, and more preferably between about 1700 and 2300 ppm by weight. Examples of such high performance nucleators include, dibenzylidene sorbitol having alkyl, alkoxy or halogen substituents on either or both aromatic rings, whereby the alkyl substituents have from 1 to 20 carbon atoms, and may be branched, linear or cycloalkyl, and combinations of such sorbitol derivatives. Other non-limiting examples include: bis(3,5-dimethyl benzylidene)sorbitol, bis(p-ethyl benzylidene)sorbitol, bis(p-methyl benzylidene)sorbitol and combinations thereof. Such clarifying agents are commercially available (e.g., MILLAD® 3988, from Milliken Chemical (Spartanburg, S.C.). Other preferred high performance nucleators include between about 300 and about 1000 ppm of sodium 2,3-methylene-bis-(4,6-di-tert-butlyphenyl)phosphate or of aluminum, hydroxybis[2,4,8,10tetrakis(1,1-dimethylethyl)-6-(hydroxy-)-12H-dibenzo[d,g][1,3,2dioxaphosphocin 6-oxidato] (available as product numbers NA-11 and NA-21, respectively, from Amfine Chemical Corp., Allendale N.J.).

In yet other embodiments, the blend, when formed into a resin and shaped into a 22 mil thick sheet, has a Haze of less than about 77% and a (Energy to Maximum Load/Energy After Maximum Load) ratio of at least about 1.6 when measured at about −20° F. (˜−29° C.). In certain preferred embodiments, the Haze is less than about 60%, and the (Energy to Maximum Load/Energy After Maximum Load) ratio is less than about 3. And, in more preferred embodiments, the Haze is less than about 30% and the (Energy to Maximum Load/Energy After Maximum Load) ratio is less than about 4.

The term Haze as used herein refers to the percentage of light which, in passing through the sample, deviates from the incident beam average, as measured using the protocol described in ASTM D-1003, incorporated herein by reference. The terms Energy to Maximum Load, and Energy After Maximum Load as used herein refer to measurements obtained using the Instrumented Impact protocol described in ASTM D-3763, incorporated herein by reference. An increase in the (Energy to Maximum load/Energy After Maximum load) ratio is thought to indicate that such resin materials can take more force, e.g., absorb more energy, before reaching the Maximum load, e.g., failing.

Yet another embodiment of the present invention is a process for forming a resin. The process includes providing a blend comprising, an impact copolymer, a random copolymer and a clarifying agent, having the chemical compositions and properties as described elsewhere herein. Any conventional technique may be used for the formation of the resin. In certain embodiments, the process may further include melting, mixing and pumping the blend to form a sheet comprising the resin.

In other embodiments, the process for forming the resin may comprise blending the ICP, as discussed above, and a clarified random copolymer. The term clarified random copolymer as used herein refers to a random copolymer already blended or mixed with the herein described clarifying agent, before blending with the ICP. In such embodiments, the process may further include adding additional amounts of the clarifying agent sufficient to provide a concentration of between about 300 and about 4000 ppm, by weight in the resin.

The process may further include melting the blend at a temperature of between about 176° C. and about 238° C., and more preferably between about 221° C. and about 232° C. The process may also include forming the sheet by heating the resin to a temperature of between about 350° F. (˜176° C.) and about 480° F. (˜248° C.), and more preferably between about 430° F. (˜221° C.) and about 450° F. (˜232° C.), and extruding the resin using a conventional extrusion apparatus. One skilled in the art understands, of course, that such process temperatures may be increased or decreased depending on the throughput rate and equipment type used.

Yet another embodiment of the present invention is a method for preparing an article of manufacture. The method comprises preparing a resin comprising a blend of an impact copolymer, a random copolymer, and a clarifying agent. The method further comprises forming an article comprising the resin. The article may be formed by any conventional fabrication process. In certain advantageous embodiments, for example, the article may be formed by injection molding, blow molding or extrusion such as cast or oriented film, sheet or profile, and thermoforming. In certain preferred embodiments the method include forming articles used in low temperature packaging applications, such as lids or containers, including low temperature storage containers.

Still another embodiment of the present invention is an article of manufacture. The article includes a resin comprising a blend of an impact copolymer, a random copolymer and a clarifying agent. The article may have any of the physical and optical properties described herein. For example, in certain embodiments, the article, when formed in a 22 mil thick sheet, has a Haze of less than about 77% and a Energy to Maximum Load/Energy After Maximum Load ratio of at least about 1.6 at about −20° F. (˜−29° C.). In yet other preferred embodiments, the article, when formed into a conventional testing bar, has a room temperature (RT; ˜23° C.) Notched Izod of at least about 1.2 ft-lbs/in (˜64 J/m). The term Notched Izod as used herein, refers to a conventional test that measures a material's resistance to impact from a swinging pendulum. In more preferred embodiments, the article has a Notched Izod of at least about 2.6 ft-lbs/in (˜138 J/m).

In still other preferred embodiments, the article, has a room temperature Gardner Mean Failure Energy of at least about 70 in·lbs (˜7.9 J). The term Gardner Mean Failure Energy, as used herein refers to a conventional method for evaluating impact strength or toughness.

Having described the present invention, it is believed that the same will become even more apparent by reference to the following experiments. It will be appreciated that the experiments are presented solely for the purpose of illustration and should not be construed as limiting the invention. For example, although the experiments described below maybe carried out in a laboratory or pilot plant, one of ordinary skill in the art could adjust specific numbers, dimensions and quantities up to appropriate values for a full scale plant.

### EXPERIMENTS

Two experiments were conducted to examine the effect of optical and physical properties of resins formed from the blends of the present invention. The resin's properties were characterized using standard protocols, developed and published by the American Society for Testing and Materials (West Conshohocken, Pa.) including: Izod Notched (ASTM D-256); Flex Modulus (ASTM D-790); Tensile Modulus (ASTM D-638); Tensile Strength at Yield (ASTM D-638); Tensile Strength at Break (ASTM D-638); Elongation at Yield (ASTM D-638); Elongation at Break (ASTM D-638); Gardner Impact (ASTM D-4226); Instrumented Impact (ASTM D-3763); Haze (ASTM D-1003); Yellowness (ASTM E-313); Gloss (ASTM D-2457); and Color (ASTM D-6290), all of which are incorporated by reference.

### Experiment 1

An experiment was performed to survey the optical and physical properties of test sample formed from resins comprised of blends having different proportions of ICP and clarified RCP. The ICP, designated as ATOFINA Petrochemicals, Inc. (ATOFINA®) 4280, comprised a crystalline composition that included about 70% of an isotactic polypropylene homopolymer and about 30% of an amorphous rubber composition that included ethylene and propylene in a ratio of 40:60 (E:P). The 4280W ICP contained a sodium benzoate nucleator. The RCP comprised a propylene homopolymer with random insertions of ethylene throughout the propylene homopolymer. Two types of RCP were evaluated. One RCP, designated as 6289MZ, contained about 2 wt % of ethylene. A second, designated as 7231M, contained about 3 wt % ethylene. Both RCPs, were clarified RCPs, that is, they contained a clarifying agent, comprising about 2000 ppm by weight of MILLAD 3988®.

Test samples were formed by blending the ICP and clarified RCP in proportions of 70:30, 60:40 and 50:50 (RCP:ICP) using a conventional blender. The blend was then transferred to a conventional extruder, melted at about 440° F. (˜227° C.) and extruded into a ˜22 mil (˜559 micron) thick sheet. The results of optical and physical tests performed on the sheets at room temperature (˜23° C.) are summarized in TABLE 1.

TABLE 1

| | | | | |
|---|---|---|---|---|
| Sample Number | 1 | 2 | 3 | 4 |

Composition

| | | | | |
|---|---|---|---|---|
| RCP 2.0 wt % E (ATOFINA 6289MZ) | ˜70 | 0 | 0 | 0 |
| RCP 2.7 wt % E (ATOFINA 7231M) | 0 | ˜70 | ˜60 | ˜50 |
| ICP (ATOFINA 4280) | ˜30 | ˜30 | ˜40 | ˜50 |
| Test Results | | | | |
| Haze, % | ˜64 | ˜63 | ˜74 | ˜81 |
| Tensile Modulus, psi × 10⁵ (kPa × 10⁵) | ˜1.6 (˜11) | ˜1.3 (˜8.9) | ˜1.3 (˜8.9) | ˜1.3 (˜8.9) |
| Tensile Strength at Yield, psi (kPa × | ˜4200 (˜2.7) | ˜3700 | ˜3700 | ˜3700 |
| 10⁴) | | (˜2.5) | (˜2.5) | (˜2.5) |
| Tensile Strength at Break, psi (kPa × | ˜5200 (˜3.6) | ˜4900 | ˜4900 | ˜4900 |
| 10⁴) | | (˜3.4) | (˜3.4) | (˜3.4) |
| Elongation at Yield, % | ˜18 | ˜21 | ˜24 | ˜20 |
| Elongation at Break, % | ˜580 | ˜596 | ˜613 | ˜592 |
| Gardner Mean Failure Weight in-lb (J) | ˜29.2 | ˜25.8 | ˜32.8 | ˜33.7 |
| | (˜3.30) | (˜2.92) | (˜3.71) | (˜3.81) |

Because the sample sheets were polished on only one surface, the Haze values were higher than expected if both sides are polished. The results, however, serve to illustrate that Haze increased only slightly with increasing proportions of ICP. However, the samples were judged to still have acceptable levels of clarity for packaging applications. Moreover, the presence of the ICP improved the Elongation at Yield and Elongation at Break.

An additional test sample sheet (Sample 5) was prepared from a resin comprising a blend analogous to that described for Sample 2 in TABLE 1, with the exception that additional quantities of the clarifying agent, MILLAD 3988®, were added. Sufficient quantities of the clarifying agent were added prior to extrusion so as to provide a concentration of about 2000 ppm of MILLAD 3988® by weight in the resin. In addition, non-nucleated ICP (ATOFINA 4280) was used. A ˜32 mil (˜813 micron) thick sheet formed from Sample 5 had a Haze value of about 28%.

### Experiment 2

A second series of experiments was performed to further evaluate the optical and physical properties of resins formed from blends comprising the same ICP, RCP and clarifying agent as described in Experiment 1, and to compare such blends to pure RCP. The ICP, designated as 4280, was non-nucleated. A nucleator free ICP was used to avoid negative interactions between the sodium benzoate nucleator and sorbitol-based clarifying agent that could increase haze. Test samples were formed by blending the ICP and clarified RCP in proportions of ˜80:20, ˜60:40 and ˜40:60 (RCP:ICP) in a conventional blender similar to that described in Experiment 1. In addition, sufficient amounts of the clarifying agent were added prior to extrusion so as to provide a final concentration of about 2000 ppm of MILLAD 3988® by weight in the resin. The resins were then formed into various shapes appropriate for optical and physical testing. The results of optical and physical tests performed on the sheets are summarized in TABLE 2; for samples including the 6289MZ RCP, and in TABLE 3, for samples including the 7231M RCP.

TABLE 2

| | | | | |
|---|---|---|---|---|
| Sample Number | 6 | 7 | 8 | 9 |

Composition

| | | | | |
|---|---|---|---|---|
| RCP 2.0 wt % E (6289MZ) | ˜100 | ˜80 | ˜60 | ˜40 |
| ICP (4280) | ˜0 | ˜20 | ˜40 | ˜60 |
| Test Results | | | | |
| IZOD Notched ft-lb/in (J/m) | ˜1.13 (˜60) | ˜2.7 (˜144) | ˜3.04 (˜163) | ˜4.2 (˜225) |
| Flex Modulus (Chord 4-8N) 10⁵ | ˜1.59 (˜11.0) | ˜1.52 (˜10.5) | ˜1.58 (˜10.9) | ˜1.56 (˜10.8) |
| psi (kPa) | | | | |
| Tensile Modulus, psi × 10⁵ | ˜1.70 (˜11.7) | ˜1.60 (˜11.0) | ˜1.63 (˜11.2) | ˜1.63 (˜11.2) |
| (kPa × 10⁵) | | | | |
| Tensile Strength at Yield, | ˜4300 (˜3.0) | ˜4000 (˜2.8) | ˜4000 (˜2.8) | ˜3800 (˜2.6) |
| psi (kPa × 10⁴) | | | | |
| Tensile Strength at Break, | ˜2700 (˜1.9) | ˜2900 (˜2.0) | ˜2900 (˜2.0) | ˜2900 (˜2.0) |
| psi (kPa × 10⁴) | | | | |
| Elongation at Yield, % | ˜14.4 | ˜15.8 | ˜15.4 | ˜14.8 |
| Elongation at Break, % | >˜118 | >˜118 | >˜122 | >˜133 |
| RT Gardner Mean Failure | ˜67.8 (˜7.70) | ˜234 (˜26.4) | ˜235 (˜26.0) | ˜230 (˜26.0) |
| weight in-lb (J) | | | | |
| −20° F. Energy To Max. Load | ˜1.4 (˜1.90) | ˜1.95 (˜2.64) | ˜2.1 (˜2.84) | ˜3.8 (˜5.15) |
| ft-lb (J) | | | | |
| −20° F. Energy After Max. Load | ˜0.90 (˜1.22) | ˜0.57 (˜0.77) | ˜0.50 (˜0.68) | ˜1.25 (˜1.69) |
| ft-lb (J) | | | | |
| −20° F. Total Energy Load ft-lb | ˜2.26 (˜3.06) | ˜2.52 (˜3.41) | ˜2.58 (˜3.49) | ˜5.05 (˜6.84) |
| (J) | | | | |
| −20° F. Energy To / After Max. | ˜1.55 | ˜3.42 | ˜4.2 | ˜3.04 |
| Load | | | | |
| Haze 20 mil, % | ˜7 | ˜31 | ˜52 | ˜59 |
| Yellowness Index | ˜2.1 | ˜0.4 | ˜−0.1 | ˜0.2 |
| Gloss 45°, % | ˜56 | ˜47 | ˜40 | ˜33 |

TABLE 3

| | | | | |
|---|---|---|---|---|
| Sample Number | 10 | 11 | 12 | 13 |

Composition

| | | | | |
|---|---|---|---|---|
| RCP 2.7 wt % E (7231M) | ˜100 | ˜80 | ˜60 | ˜40 |
| ICP (4280) | ˜0 | ˜20 | ˜40 | ˜60 |
| Test Results | | | | |
| IZOD Notched ft-lb/in (J/m) | ˜1.5-2 (˜80-106) | ˜2.39 (˜139) | ˜3.5 (˜187) | ˜5.26 (˜281) |
| Flex Modulus (Chord 4-8N) 10⁵ | ˜1.20 (˜8.27) | ˜1.20 (˜8.27) | ˜1.3 (˜8.96) | ˜1.4 (˜9.65) |
| psi (kPa) | | | | |
| Tensile Modulus, psi × 10⁵ | ˜1.30 (˜8.96) | ˜1.36 (˜9.37) | ˜1.40 (˜9.65) | ˜1.50 |
| (kPa × 10⁵) | | | | (˜10.3) |
| Tensile Strength at Yield, | ˜3500 (˜2.4) | ˜3600 (˜2.5) | ˜3600 (˜2.5) | ˜3700 (˜2.5) |
| psi (kPa × 10⁴) | | | | |
| Tensile Strength at Break, | ˜2700 (˜1.9) | ˜2700 (˜1.9) | ˜2800 (˜1.9) | ˜2800 (˜1.9) |
| psi (kPa × 10⁴) | | | | |
| Elongation at Yield, % | ˜15.8 | ˜15.7 | ˜15.2 | ˜14.9 |
| Elongation at Break, % | >˜120 | >˜117 | >˜118 | >˜118 |
| RT Gardner Mean Failure | ˜238 (˜26.9) | ˜234 (˜26.9) | ˜230 (˜26.0) | ˜228 (˜25.8) |
| weight in-lb (J) | | | | |
| −20° F. Energy To Max. Load | ˜2.8 (˜3.79) | ˜2.8 (˜3.79) | ˜2.1 (˜2.84) | ˜1.30 (˜1.76) |
| ft-lb (J) | | | | |
| −20° F. Energy After Max. Load | ˜0.90 (˜1.22) | ˜0.70 (˜0.95) | ˜0.60 (˜0.81) | ˜1.30 (˜1.76) |
| ft-lb (J) | | | | |
| −20° F. Total Energy Load ft-lb | ˜3.70 (˜4.99) | ˜3.50 (˜4.74) | ˜2.61 (˜3.65) | ˜2.60 (˜3.52) |
| (J) | | | | |
| −20° F. Energy To / After Max. | ˜3.11 | ˜4.00 | ˜3.50 | ˜1.00 |
| Load | | | | |
| Haze 20 mil, % | ˜7 | ˜30 | ˜47 | ˜59 |
| Yellowness Index | ˜1.1 | ˜1.2 | ˜0.5 | ˜−0.2 |
| Gloss 45°, % | ˜58 | ˜47 | ˜40 | ˜39 |

As indicated in TABLE 2, the flexural and tensile modulus, and tensile strength, were only moderately affected by the addition of ICP to 6289MZ. As noted in Experiment 1, the presence of the ICP improved the Elongation at Yield and Elongation at Break. The notched IZOD impact value increased with the addition of ICP, as did the room temperature Gardner impact value. Instrumented impact measurements at about −20° F. (˜−29° C.) indicated improvements in total energy load values with increasing ICP. The effect of ICP is also apparent from the ratio, Energy until Maximum load/Energy After Maximum load, which progressively increased with increasing proportions of ICP.

Turning to the sample's optical properties, as indicated in TABLE 2, for 20 mil sheets prepared from Samples 6-9, the Haze progressively increased with increasing proportions of ICP. Additional Haze measurements were made for sample sheets of ˜40 (˜1016 microns), ˜60 (˜1470 microns) and ˜80 mil (˜1960 microns) thickness. Haze was observed to increase with increasing thickness, although less progressively so for samples having ICP:RCP ratios of about 60:40 to about 40:60 and a thickness of at least about 40 mil.

Yellowness index, present in TABLE 2, was lower in ICP containing samples as compared to the sample containing 6289MZ RCP only (Sample 6). Gloss, measured at an angle of about 45°, progressively decreased with increasing proportions of ICP. Additional experiments, not shown in TABLE 2, were conducted to compare the Hunter Color of ICP containing samples to 6289MZ RCP. Color L, Plaque (Hunter scale) ranged from about 79 to about 83 (Samples 7-9), as compared to about 76 for 6289MZ RCP (Sample 6). All of the sample's color values remained around a 1 color b value.

Similar to addition of the ICP to 6289MZ, the addition of ICP to 7231M RCP had only moderate effects on flexural and tensile modulus, and tensile strength. (TABLE 3) The addition of the ICP to 7231M RCP resulted in a slight decrease in the Elongation at

Yield and Elongation at Break. The notched IZOD impact value increased with the addition of the ICP, however, the room temperature Gardner value decreased slightly. The total energy load values measured at −20° F. (−29° C.) decreased with the addition of the ICP. The addition of ICP up to about 40% increased the Energy to Maximum Load/Energy After Maximum load ratio.

Also similar to addition of the ICP to 6289MZ, the addition of ICP to 7231M RCP, for 20 mil sheets prepared from Samples 11-13, the Haze progressively increased with increasing proportions of ICP (TABLE 3). Haze was observed to increase with increasing thickness, for example increasing from about 30% to 60% Haze at a thickness of 20 mil, to about 55 to about 80% Haze at a thickness of 40 mil, with smaller increases in Haze at sheet thickness greater than about 40 mil.

Yellowness index, decreased with progressively increasing proportions of the ICP. (TABLE 3) Gloss at 45° progressively decreased with increasing proportions of ICP. Additional experiments, not shown in TABLE 3, conducted to compare the Color of ICP containing samples to 7231 RCP were similar to the results described for the addition of the ICP to 6289MZ RCP.

### Experiment 4

An experiment was performed to survey the optical and physical properties of test sample formed from resins comprised of blends having different proportions of ICP and clarified RCP. The ICP, designated as ATOFINA® Petrochemicals, Inc. (ATOFINA®) 4280, comprised a crystalline composition that included about 70% of an isotactic polypropylene homopolymer and about 30% of an amorphous rubber composition that included ethylene and propylene in a ratio of 40:60 (E:P) and having a 1.3 melt flow rate. The 4280W ICP contained a sodium benzoate nucleator. The RCP comprised a propylene homopolymer with random insertions of ethylene throughout the propylene homopolymer. Two types of RCP were evaluated. One RCP, designated as 6289MZ, contained a clarified ethylene-propylene random copolymer containing about 2 wt % of ethylene and having a 1.5 melt flow rate. A second, designated as 3289MZ, was a clarified polypropylene homoploymer having a 1.8 melt flow rate. Both RCPs, were clarified RCPs, that is, they contained a clarifying agent, comprising about 2000 ppm by weight of MILLAD 3988®. Another RCP, ATOFINA® EOD00-35, included a proplyene/ethylene, where the ethylene comprised from about 0.15 wt % to about 4.0 wt % of the RCP having a 2.3 melt flow rate, and was synthesized using a metallocene catalyst.

Test samples were formed by blending the ICP and clarified RCP in proportions of 70:30, 60:40 and 50:50 (RCP:ICP) using a conventional blender. The blend was then transferred to a conventional extruder, melted at about 440° F. (˜227° C.) and extruded into a ˜22 mil (˜559 micron) thick sheet. The results of optical and physical tests performed on the sheets at room temperature (˜23° C.) are summarized in TABLE 4.

TABLE 4

| | | Instrumental Impact | Tensile Modulus | Tensile Strength |
|---|---|---|---|---|
| Property Measured | Haze % | (−20° F.) Ft-Lb | (kpsi | Yield (psi) |

Blend Wt. %

| | | | | |
|---|---|---|---|---|
| 4280W 100% | ˜80 | ˜2.77 | ˜190 | ˜3355 |
| 80% 4280W/20% 6289MZ | ˜80 | ˜1.5 | ˜189 | ˜4044 |
| 40% 4280W/60% 6289MZ | ˜49 | ˜1.6 | ˜189 | ˜4044 |
| 20% 4280W/80% 6289MZ | ˜49 | ˜0.36 | ˜180 | ˜4148 |
| 80% 4280W/20% EOD00-35 | ˜80 | ˜2.4 | ˜214 | ˜3726 |
| 40% 4280W/60% EOD00-35 | ˜66 | ˜0.94 | ˜231 | ˜4416 |
| 20% 4280W/80% EOD00-35 | ˜47 | ˜0.36 | ˜250 | ˜4909 |
| 80% 4280W/20% 3289MZ | ˜80 | ˜2.04 | ˜187 | ˜3560 |
| 40% 4280W/60% 3289MZ | ˜81 | ˜1.5 | ˜200 | ˜4177 |
| 20% 4280W/80% 3289Mz | ˜56 | ˜0.34 | ˜200 | ˜4509 |

As seen from the foregoing table, the blends comprising the EOD00-35 RCP provided superior clarity, tensile modulus and tensile strength, which may be particularly advantageous in certain commercial applications.

Although the present invention has been described in detail, those skilled in the art should understand that they can make various changes, substitutions and alterations herein without departing from the and scope of the invention.

1. A blend comprising:
about 20 wt % to about 60 wt % of an impact copolymer;
about 300 to about 4000 ppm by weight of a clarifying agent; and
a random copolymer comprising a balance of said blend.

2. The blend as recited in claim 1 wherein said blend, when formed into a resin and extruded into a about 22 mil thick sheet, has a Haze of less than about 77% and a Energy to Maximum Load/Energy After Maximum Load ratio of at least about 1.6 at about −29° C.

3. The blend as recited in claim 1 wherein said blend, when formed into a resin and extruded into a about 22 mil thick sheet, has a Haze of less than about 64% and a Energy to Maximum Load/Energy After Maximum Load ratio of at least about 4 at about −29° C.

4. The blend as recited in claim 1 wherein said blend comprises about 30 wt % to about 50 wt % of said impact copolymer, about 1700 and 2300 ppm by weight of said clarifying agent, and balance said random copolymer.

5. The blend as recited in claim 1 wherein said blend comprises about 30 wt % of said impact copolymer, about 300 to about 4000 ppm by weight of said clarifying agent, and balance of said random copolymer.

6. The blend as recited in claim 1 wherein said impact copolymer is nucleator free, has a melt flow between about 0.1 g/10 min and about 5 g/min and has a crystalline composition comprising a homopolymer, or copolymer containing less than about 5 wt % of a comonomer, and an amorphous rubber composition comprising about 7 to about 22 weight % of said impact copolymer, said amorphous rubber having an ethylene:propylene component ratio between about 30:70 to about 50:50 by weight.

7. The blend as recited in claim 1 wherein said random copolymer has a melt flow between about 0.1 g/10 min and about 10 g/min and comprises a propylene copolymer containing ethylene groups randomly inserted between propylene groups, said ethylene groups comprising from about 0.2 wt % to about 4 wt % of said random copolymer.

8. The blend as recited in claim 1 wherein said clarifying agent is a dibenzylidene sorbitol containing a substitutant having 20 carbons or less selected from the group consisting of:
alkyl;
alkoxy; and
halogen.

9. The blend as recited in claim 1 wherein said random copolymer is a metallocene catalyzed ethylene propylene copolymer.

10. The blend as recited in claim 9 wherein said metallocene catalyzed ethylene propylene copolymer and ethylene comprises from about 0.15% to about 4.0% weight percent of said metallocene catalyzed ethylene propylene copolymer.

11. The blend as recited in claim 1 wherein said impact copolymer is a metallocene catalyzed impact copolymer.

12. A process for forming a resin comprising:
providing a blend comprising:
about 20 wt % to about 60 wt % of an impact copolymer;
about 300 to about 4000 ppm by weight of a clarifying agent; and
an ethylene-propylene random copolymer comprising a balance of said blend.

13. The process as recited in claim 12, further including melting, mixing said blend to form a resin and pumping said blend to form a sheet or parison comprising said resin.

14. The process as recited in claim 12 wherein said blend comprises said impact copolymer and a clarified random copolymer comprising said random copolymer containing said clarifying agent.

15. The process as recited in claim 14 wherein said mixing further includes adding said clarifying agent sufficient to provide a concentration of between about 1700 and 2300 ppm by weight.

16. The process as recited in claim 13 wherein said melting comprises heating said blend to a temperature of between 176° C. and about 238° C.

17. The process as recited in claim 13 wherein said forming said sheet comprises heating said resin to a temperature of between about 176° C. and about 238° C. and extruding said resin.

18. The process as recited in claim 12 wherein providing a blend includes providing a blend wherein said random copolymer is a metallocene catalyzed ethylene propylene copolymer.

19. The process as recited in claim 18 wherein ethylene comprises from about 0.15% to about 4.0% weight percent of said metallocene catalyzed ethylene propylene copolymer.

20. The process as recited in claim 12 wherein providing a blend includes providing a blend wherein said impact copolymer is a metallocene catalyzed impact copolymer.

21. A method for preparing an article of manufacture comprising:
preparing a resin comprising a blend of:
about 20 wt % to about 60 wt % of an impact copolymer;
about 300 to about 4000 ppm by weight of a clarifying agent; and
a random copolymer comprising a balance of said blend; and
forming an article comprising said resin.

22. The method as recited in claim 21 wherein said forming comprising a fabrication process selected from the group consisting of:
injection molding;
blow molding; and
extrusion.

23. The method as recited in claim 21 wherein said article formed is a lid or a container used in low temperature packaging applications.

24. The method as recited in claim 21 wherein preparing a resin includes preparing a resin wherein said random copolymer is a metallocene catalyzed ethylene propylene copolymer.

25. The method as recited in claim 24 wherein ethylene comprises from about 0.15% to about 4.0% weight percent of said metallocene catalyzed ethylene propylene copolymer.

26. The method as recited in claim 21 wherein preparing a resin includes preparing a resin wherein said impact copolymer is a metallocene catalyzed impact copolymer.

27. An article of manufacture comprising:
a resin comprising a blend of:
about 20 wt % to about 60 wt % of an impact copolymer;
about 300 to about 4000 ppm by weight of a clarifying agent; and
a random copolymer comprising a balance of said blend.

28. The article as recited in claim 27 wherein said article has a Notched Izod of at least about 64 J/m at 23° C.

29. The article as recited in claim 27 wherein said article has a Notched Izod of at least about 138 J/m at 23° C.

30. The article as recited in claim 27 wherein said article has a Gardner Mean Failure Energy of at least about 7.9 J at 23° C.
